(19) United States
(12) Patent Application Publication
(10) Pub. No.: US 2018/0071971 A1
(43) Pub. Date: Mar. 15, 2018

(54) HEATER FOR THERMOFORMABLE MATERIALS

(71) Applicant: Rechargeable Battery Corporation, College Station, TX (US)

(72) Inventors: John Beckerdite, College Station, TX (US); Adam Laubach, College Station, TX (US); Darko Marquez, College Station, TX (US); Christopher Pedicini, Franklin, TN (US)

(21) Appl. No.: 15/564,460

(22) PCT Filed: Apr. 7, 2016
(86) PCT No.: PCT/US2016/026378

§ 371 Date: Oct. 5, 2017

Related U.S. Application Data
(60) Provisional application No. 62/143,889, filed on Apr. 7, 2015.

(51) Int. Cl. B29C 51/02; B29C 51/42; B32B 15/085; F24J 1/00

(52) U.S. Cl. CPC B29C 51/02; F24J 1/00; B32B 15/085; B29C 51/421

(57) ABSTRACT

A thermoformable article having a body constructed using material which is rigid at temperatures below a thermoformable temperature and becomes formable when heated to a temperature above a thermoformable temperature and a heater material in thermal contact with the body when the heater material is activated, wherein the heat generated by the heater material when activated is provided by an enthalpy of solution of the heater material.

### RELATED APPLICATIONS

The present application claims priority to U.S. Provisional Patent Application No. 62/143,889 filed Apr. 7, 2015 the contents of which are expressly incorporated herein by reference.

### FIELD OF THE INVENTION

The present invention relates to a thermoformable article and its components, and more specifically to a thermoformable article having a heater which utilizes water and a reactant to generate the heat required to form the article.

### BACKGROUND OF THE INVENTION

Thermoformable articles typically become moldable or formable when a heat source is applied to them. In some known articles, a heater or the like may be included with or coupled to the article. For example, U.S. Pat. Pub. Nos. 2015/0257917 and 2015/0257918 to Rechargeable Battery Corporation, a thermoformable article in the form of a splint is disclosed wherein the article includes a heater which couples to the exterior of the article. The heaters used for thermoformable articles are typically oxygen activated heaters like those described in the printed publications to Rechargeable Battery Corporation.

Heat sources using other chemical reactions can be used to generate heat which may be used to heat thermoformable articles to a formable temperature. When, for example, an inorganic salt having higher hydration energy than lattice energy is hydrated, energy in the form of heat is released. The available heat of hydration in such instances will depend on the choice of salt and the final degree of hydration of the salt. As such, a careful selection of the salt and proper ratio of the salt to water are key considerations when wanting to generate enough heat to make the thermoformable material moldable, while at the same time avoiding excessive temperatures which may burn users of the thermoformable material.

An additional problem with using a heat source utilizing salt and water to generate heat is that the combined salt and water may create an undesirable wet, sticky substance which can irritate a user and be uncomfortable. Washing the resulting substance away from the thermoformable material may be difficult once fit to a user or if a wicking or fabric layer is used in conjunction with the salt and/or water.

Depending on the salt used in the heating device and location parameters like the relative humidity, the salt may also continue to absorb water out of the air. Continued absorption of water may cause the salt to continue to generate heat while become heavier as the water is absorbed. Continued heating can lead to higher than desired temperatures or an extended setting time of the thermoformable material.

The present invention is provided to solve these and other issues.

### SUMMARY OF THE INVENTION

The present invention is directed to a thermoformable article which includes a thermoformable body and a heat source, where a solution of a reactant or heater material, like for example water and an anhydrous salt, are, at the desired time of heating, mixed together in order to generate heat. The hydration energy of the used heater material (such as a salt like anhydrous MgCl₂) should be greater than the lattice energy which will cause a burst of energy (released as heat) when the heater material and water are mixed.

In order to avoid premature or undesired heating, the water and the heater material, i.e. salt, should be stored and transported separately, and only introduced to each other at the desired time of heating. A thickening agent could be added to the heater material and/or the water to increase the viscosity. A wax material could be introduced to the heater material and/or water to increase the ability of the system to store energy and heat for longer periods of time.

It is also contemplated that part of the packaging may include in part a liquid impermeable, gas permeable, film such as flashspun high-density polyethylene fibers. Although the use of a separate water pouch may be used, it is also contemplated that water may be applied via other means, such as pouring water on to the thermoformable article. The amount and type of salt, water, thickening agent, and/or wax will determine the heat of the final mixture.

The heating element of the present invention utilizes the enthalpy of solution (heat of hydration) to provide heat. For example, in some cases when an anhydrous salt is mixed with water, energy is released as it goes into solution. The heat given off may be used to heat a thermoformable product. Anhydrous magnesium chloride (MgCl₂) is an example of a salt that gets quite hot when it is wetted.

According to one aspect of the invention, a thermoformable article is provided. The thermoformable article includes a thermoformable body constructed using material which is rigid at temperatures below a thermoformable temperature and becomes formable when heated to a temperature at least as high as the thermoformable temperature. Materials may be used which become thermoformable at, for example, 140 degrees Fahrenheit, 160 degrees Fahrenheit, etc. Examples of materials which may be used to create the body include, but are not limited to, polylactic acid (PLA) polymer, cellulose acetate butyrate, polycaprolactone, ethylene vinyl acetate, poly(caprolactone), poly(hydroxybutyrate), polyethylene, polypropylene, polystyrene and combinations thereof.

The thermoformable article further includes a heater material, the heater material being in thermal contact with the body when the heater material is activated. The heat generated by the heater material once the heater material is activated is provided by an enthalpy of solution of the heater material.

In order to activate the heater material, the thermoformable article may include a pouch or packet of water. Regardless of how housed, the water should initially be isolated from the heater material. Once combined, the heater material should have a weight between 5% and 20% of the total combined weight of the heater material the water and any other additives like wax or a thickening agent, for example. A heater material should be selected so that it becomes activated when the water is combined therewith.

The heater material may a salt or mixture of salts having a negative enthalpy of solution, and wherein the salt or mixture of salts is activated through hydration. For example, the heater material may include MgCl₂, KCl, KBr, NaCl, LiCl, LiI, CuSO₄, FeCl₂, MgSO₄, CaCl₂, CaO and mixtures thereof. The heater material may be a salt or mixture of salts having a negative enthalpy of solution, and wherein the salt or mixture of salts is activated through hydration. The solution resulting from the hydration of the heater material or salt or the mixture of salts preferably has a relative humidity in the range of 40%-70%, and more preferably a relative humidity in the range of 50%-60%. Having a relative humidity within those ranges will prevent the heater material from continuing to absorb water from the environment after being activated by the water provided or added by a user.

In some embodiments of the invention, the heater material may be physically isolated from the body. For example, the thermoformable article may include a barrier film bag or the like, the barrier film bag may be removably attached to a first side of the body and may have a first compartment and a second compartment separated by a frangible seal. The heater material may be housed within the first compartment and water may be housed in the second compartment, and the breaking of the frangible seal causes the heater material and water to mix, activating the heater material. In order to prevent damage to the heating portion and potential injury to a user, the first compartment may include a vent hole to allow steam and air pressure generated from the combining of the heater material and the water to escape the barrier film bag so the bag does not explode.

In other embodiments where the heater material is physically isolated from the thermoformable body, rather than use a bag having one or multiple compartments, the thermoformable article may include a barrier film or the like. When a barrier film rather than a bag is used, the heater material may be deposited on a first side of the barrier film and covered with a removable, peelable flap, while the second side of the barrier film is removably attached to a surface of the thermoformable body. An activating agent like water may then be provided in a separate container with the thermoformable article, or may be supplied by a user from an external source.

In other embodiments of the invention, the heater material may be integrated or included directly with the thermoformable body. In order to hold and accommodate the heater material and prevent the heater material from escaping before and after activation, the body may include one or more cavities formed in a first surface of the body, the plurality of cavities having heater material embedded therein. The thermoformable article may then also include a wicking layer which is removably engaged with the first surface of the body to cover the first surface, the plurality of cavities and the heater material embedded therein.

In some embodiments where the heater material is integrated within a cavity or a plurality of cavities formed in a surface of the thermoformable body, the thermoformable article may include a barrier film bag having a first compartment and a second compartment separated by a frangible seal. The first compartment may house an activator for the heating material, like for example water, while the second compartment houses the body having a cavity or a plurality of cavities with heater material embedded therein and any wicking layer which may or may not be fixed over the cavities and heater material. The activator will mixes with the heater material when the frangible seal is broken, causing the heater material to become activated. A vent may be provided in the second cavity to allow for the escape of steam and air pressure as the heater material is activated and heated.

In other embodiments where the heater material is integrated within a cavity or a plurality of cavities formed in a surface of the body, the thermoformable article may include a barrier film bag having a removable portion and a single main interior pouch for housing the body, the heater material and any wicking layer which may or may not be fixed to the body over the cavity or cavities and heater material. Within the main pouch, a second pouch containing an activator like water may be provided. Removal of the removable portion of the bag will allow access to the thermoformable body and integrated heater material and any wicking layer, as well as the second pouch holding the activator for the heating material. The removable portion may be removed using any method or means known in the art. For example, the barrier film bag may include a notch for tearing away the removable portion.

In yet other embodiments where the thermoformable body includes a cavity or a plurality of cavities having heater material embedded therein, the thermoformable article may include a barrier film bag having a removable portion and a first compartment and a second compartment separated by a permanent heat seal. The first compartment may house an activator for the heater material, like for example water or water in the form of a water soaked pad, while the second compartment houses the body, the heater material and any wicking layer which may or may not be removably engaged with the body to cover the heater material. Removal of the removable portion of the bag will allow access to the thermoformable body and integrated heater material and any wicking layer, as well as the activator for the heating material, for example the water soaked pad or sponge. The removable portion may be removed using any method or means known in the art. For example, the barrier film bag may include a notch for tearing away the removable portion.

It is to be understood that the aspects and objects of the present invention described above may be combinable and that other advantages and aspects of the present invention will become apparent upon reading the following description of the drawings and detailed description of the invention.

### BRIEF DESCRIPTION OF THE DRAWINGS

FIG. 1 of the Drawings is an exploded perspective view of one embodiment of the thermoformable body of the present invention;

FIG. 2 of the Drawings is a top perspective view of an embodiment of the present invention;

FIG. 3 of the Drawings is a top view of an embodiment of the present invention;

FIG. 4A of the Drawings is a top perspective view of an embodiment of the present invention;

FIG. 4B of the Drawings is a side view of the embodiment of the present invention shown in FIG. 4A;

FIG. 5 of the Drawings is an exploded perspective view of an embodiment of the present invention; and

FIG. 6 of the Drawings is an exploded perspective view of an embodiment of the present invention.

### DETAILED DESCRIPTION OF THE INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

FIGS. 1-6 show multiple embodiments of a thermoformable article as contemplated by the invention. In each case, the thermoformable article includes a thermoformable body (generally shown as a rectangular element, though it should be understood that the body may take any shape) and a heater material. In various embodiments the body may include a cavity or a plurality of cavities for holding and trapping heater material (for example salt or a mixture of salts) and the thermoformable article may further include a wicking layer to help cover and house the heater material, an activator (for example water) for the heater material, a barrier and/or barrier bag, a vent, and various seals to prevent premature or unwanted activation of the heater material. The thermoformable article may also include thickening agents and/or wax which may be mixed in with the heater material and/or the activating agent in order to make the resulting combination of heater material and activator more viscous and extend the heating time of the activated heater material.

FIG. 1 shows an exemplar thermoformable body which may form a thermoformable article itself, or be used in combination with additional elements in some embodiments of the thermoformable article discussed herein. As seen in FIG. 1, thermoformable body 10 includes a plurality of cavities 12 which have heater material 14, for example salt or a salt mixture, embedded therein. Shown as detached, wicking layer 16 may engage body 10 overtop cavities 12 and heater material 14 to create a barrier between the heater material and atmosphere, and help trap the heater material within the cavities before and after activation. Body 10 may also include a non-reactive filler which may be mixed in with heater material 14 which may act as a heat retention material and/or an activator absorbent and/or a heat regulator to control the heat output of the heater material once activated.

The wicking layer may be attached to body 10 in any manner known in the art, including heat bonding to the body or using an adhesive. In either case, it is preferable, though not required, that the wicking layer be removably engaged with the body so that the wicking layer can be removed once heating is completed and the body is formed in order to decrease the weight of the body, and allow a user to wash way or remove any heater material and activator which is trapped in or under the wicking layer. For example, the wicking material may be heat bonded to the body at a temperature, or may be adhered to the body in a manner, that allows the user to “peel” the wicking layer off once the heating is done so the user may wash away the heater material.

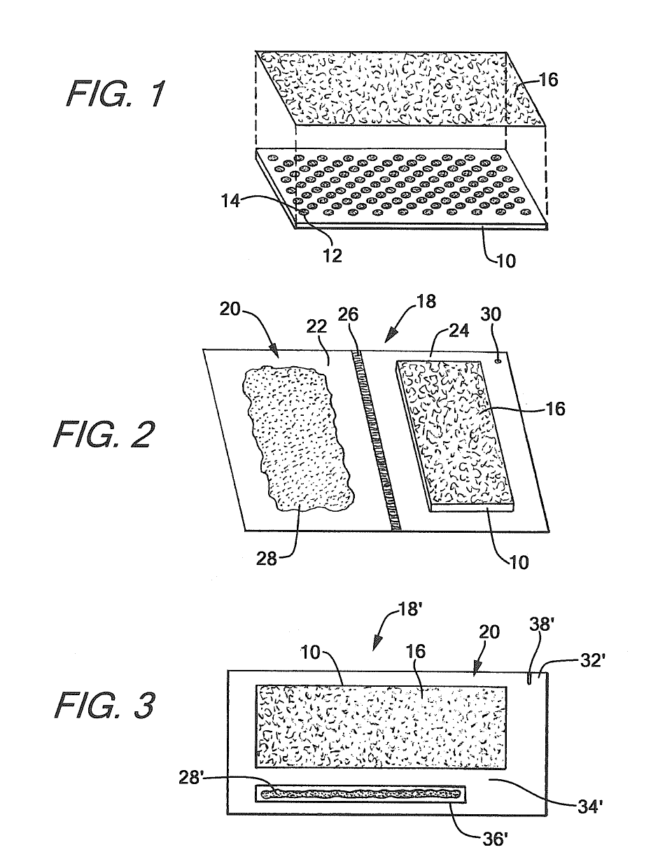

Thermoformable body 10 essentially includes everything required to form the body except an activator to cause the activation of heater material 14. In order to activate the heater material, a user may provide an activator, for example water, by introducing any required activator to the wicking layer, allowing it to absorb and/or seep through and activate heater material 14. The activator may be provided by a user, for example, from an external source, or may be included with the thermoformable body. FIGS. 2, 3, 4A and 4B show various embodiments of a thermoformable article having the thermoformable body, heater material, and wicking layer combination shown in FIG. 1, as well as a required activator which is isolated from the heater material to prevent premature activation.

FIG. 2, for example, shows a thermoformable article 18 which includes a barrier film bag 20 having a first compartment 22 and a second compartment 24 separated by a frangible seal 26. Housed within first compartment 22 is activator 28, which may be for example, water. Housed within second compartment 24 is the combination of body 10, wicking layer 16 and, though covered by the wicking layer in FIG. 2, the heater material embedded in cavities as shown in FIG. 1. Second compartment 24 further includes vent 30.

In this configuration, when activation of the thermoformable article is desired, frangible seal 26 is broken by applying pressure to first compartment 22 for example, allowing activator 28 to mix with the heater material by passing through wicking layer 16. Once activated, the heating material will begin generating heat with any resulting steam or building of air pressure being vented through vent 30 in turn causing the heating of thermoformable body 10. Once the body is heated to its malleable point and becomes formable, a user may remove the body from bag 20 and form the body as desired. Once heating and formation are complete, the user may then remove the wicking layer and rinse the thermoformable body to remove any remaining activator and/or heater material.

FIG. 3 shows another embodiment of a thermoformable article having a thermoformable body, heater material, wicking layer and activator as shown in FIG. 1.

As seen in FIG. 3 thermoformable article 18′ includes a barrier film bag 20′ which has a removable portion 32′ and surrounds and interior pouch 34′. Housed within pouch 34′ is thermoformable body 10, wicking layer 16, and, though covered by the wicking layer in FIG. 3, the heater material embedded in cavities as shown in FIG. 1. Also within pouch 34′ is container or second pouch 36′ which contains activator 28′.

When activation of the heating material and formation of the body in the embodiment shown in FIG. 3 is desired, a user may remove removable portion 32′ from bag 20′, obtaining access to both body 10 and second pouch or container 36′. Activator 28′ may be accessed by opening second pouch 36′ and introduced to wicking layer 16, again causing the activation of the heating material embedded within the cavities underneath. Once heating and formation is complete, wicking layer 16 may again be removed from body 10 and any residual heating material and/or activator washed away.

Removable portion 32′ in the embodiment shown in FIG. 3 may be removed using any known method, and may be fully or partially removed, or in some cases merely opened, as required in order to generate access to body 10 and second pouch 36′. For example, removable portion 32′ may be cut or peelable, or may be opened by pulling a portion of bag 20′ apart. In order to make access easier, bag 20′ may be provided with notch 38′ and/or may be scored to create starting point to tear away some or all, of the removable portion.

Second pouch or container 36′ may likewise take any form known in the art capable of housing and sealing, while permitting selective access to, an activator which may be, for example, water or water with thickeners or wax added thereto. For example, the second pouch may be a barrier bag similar to barrier bag 20′ or may be a vial or container having a removable lid or end.

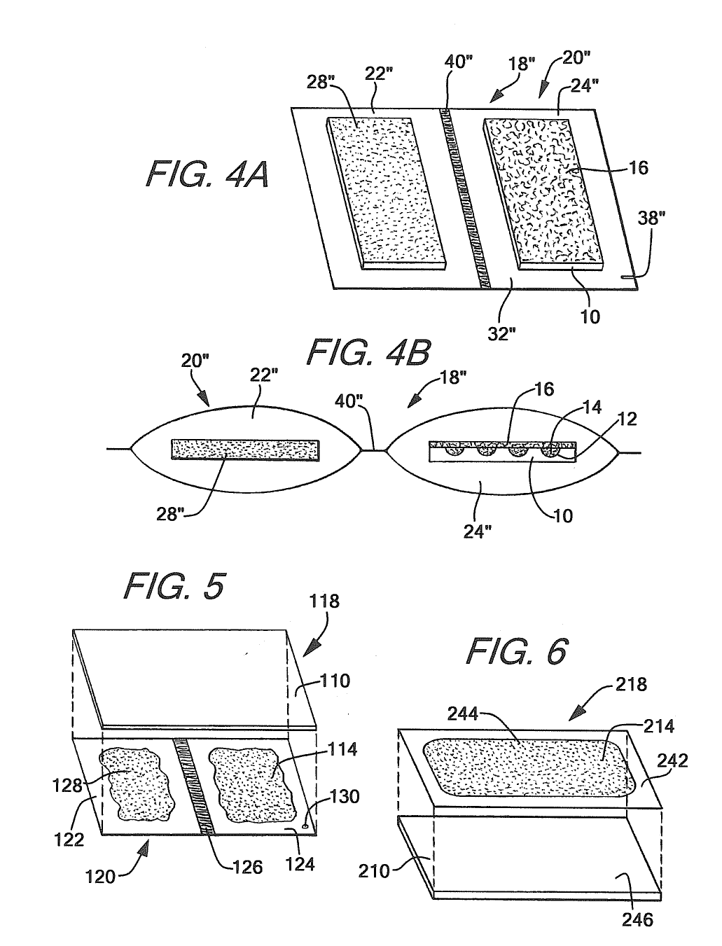

FIGS. 4A (top view) and 4B (side view of FIG. 4A) show another embodiment of a thermoformable article having a thermoformable body, heater material, wicking layer and activator as shown in FIG. 1.

Similar to the embodiment shown in FIG. 2, as seen in FIGS. 4A and 4B, thermoformable article 18″ may include a barrier film bag 20″ having a first compartment 22″ housing an activator 28″ and a second compartment 24″ housing the combination of thermoformable body 10, wicking layer 16 and heating material 14 embedded within cavities 12 as shown in phantom in FIG. 4B. Rather than have a frangible seal separating the first and second compartments, thermoformable article 18″ may include a permanent seal 40″, heat or otherwise, between the two compartments to prevent premature or unwanted activation.

In order to access the first and second compartments and activate the heater material and ultimately form body 10, bag 20″ may include a removable portion 32″ which may be substantially similar and removable in the same manners discussed with respect to the embodiment shown in FIG. 3. Once removable portion 32″ is opened and/or partially or fully removed from bag 20, a user may remove activator 28″ and body 10, and introduce activator 28″ to wicking layer 16 to activate heater material 14 embedded in cavities 12 formed in body 10. As with the previous embodiments, once heating and formation of body 10 are complete, wicking layer 16 may be removed and the thermoformable body washed and rinsed to remove any remaining heater material and/or activator.

Rather than use water as an activator, the embodiment shown in FIGS. 4A and 4B, or any of the embodiments discussed herein, may instead use a water soaked pad or sponge 28″ which is sealed to prevent loss of moisture. Using a soaked pad or sponge like material rather than simply water or some other activator solution has the advantage of avoiding spills, loss of necessary water, and potentially avoiding some post formation clean up.

Thus far, each of the embodiments discussed herein have include a thermoformable body which has cavities to allow for the integration of a heater material therewith. While integrating the heater material with the body and providing direct contact between the material and body may provide for the most efficient and best heat transfer, when an activator like water and a heater material like a salt or salt mixture is used, the resulting compound can be difficult to clean up and can result in an uncomfortable user experience.

Therefore, the present invention further contemplates thermoformable articles which have a thermoformable body which is isolated from a heater material and/or activator to allow for easier clean up and removal of an activated and/or spent heater material once the body is fully formed. An exemplary embodiment is shown in FIG. 5.

In FIG. 5, a thermoformable article 118 includes a thermoformable body 110 which may have a substantially uniform surface, include cavities or have any other formations desired created in one or more surfaces of the body. The complete article may then also include a barrier film bag 120 which includes a first compartment 122 filled with an activator 128, like for example water, and a second compartment 124 filled with heater material 114, like for example salt or a salt mixture, with the two compartments being separated by a frangible seal 126. In order to avoid an explosion of the barrier bag, vent 130 may be provided to allow for the venting of any steam or air pressure which builds up as a result of the activation and heating of the heater material.

In order to activate the heater material, the frangible seal may be broken by applying pressure to the first compartment. Once activated, the barrier bag may be adhered to or placed on a surface of the thermoformable body. Once heating and formation are complete, the barrier bag may be removed from the thermoformable article and discarded. Since the heater material and activator are enclosed and isolated from the thermoformable body, there is no need to wash away and residual heater material and/or activator from the body as the material and activator never come into contact with the body.

FIG. 6 shows a further alternative to a thermoformable article which as direct engagement between the heater material and thermoformable body.

As seen in FIG. 6, a thermoformable body 210 may be provided which may have a substantially uniform surface, include cavities or have any other formations desired created in one or more surfaces of the body. Article 218 may include a heat permeable barrier film layer 242, which has heater material 214 disposed on one side thereon, while an opposing side of the barrier film layer (the bottom side in FIG. 6) engages with surface 246 on body 210. In order to prevent direct engagement between the heater material and the thermoformable body, the barrier film may be impermeable to both solids and liquid.

A flap or seal 244 may be disposed over heater material 214 in order to prevent premature or unwanted activation of the heater material, as well as to hold and prevent the escape of the heater material. Wicking material or a wicking layer may be disposed between flap or seal 244 in order to prevent heater material from being pulled away from barrier film layer 242 when the flap or seal is removed, and to prevent the heater material from spilling or dispersing once the flap or seal is removed and when activator is added to the heater material.

When activation of heater material 214 is desired, flap or seal 244 may be removed and an activator like water added to the heater material. Once heating and formation of body 210 is complete, barrier film 242, along with heater material 214 and any activator and wicking layer can be removed from body 210. Since there is no direct contact between the body and heater material and/or activator, body 210 should be clean and not require additional clean up.

An activator may be provided with thermoformable article 218 or supplied by a user. For example, it should be understood that thermoformable body 210, barrier film layer 214, heater material 214 and flap or seal 244 may replace the combination of body 10, wicking layer 16 and heater material 14 in any of the embodiments shown in FIGS. 2-4B. Rather than provide a thermoformable body which is in direct contact with heater material as shown in FIG. 1, the thermoformable body included with thermoformable articles 18, 18′ and 18″ may be isolated from the heater material using a barrier film as shown in FIG. 6.

Regardless of the embodiment, the heater material should be a material where the hydration energy is greater than the lattice energy. When such a material is mixed with activator, the result will be a burst of energy, which will be released as heat. The enthalpy of solution (heat of hydration) of the resulting mixing of the heater material and activator is used to provide heat. As has been mentioned throughout, one such combination of heater material and activator which will result in the generation of such heat is salt or a mixture of salts and water, or a solution or mixture of water having other elements added like thickening agents or wax. Anhydrous magnesium chloride (MgCl₂) is an example of a salt that gets quite hot when it is wetted.

The amount of heat generated by a salt and water solution, must be enough to heat the thermoformable body to a thermoformable temperature, but should be kept at a level where risk of bums or and uncomfortable user experience can be avoided as much as possible. The following graph shows the heat generated from the enthalpy of solution of MgCl₂ at different concentrations, with the temperatures being measure proximate a middle area of a beaker containing a solution of MgCl₂ and water.

As can be seen in the graph above, the % of salt in the resulting solution has a progressive correlation with the temperature—as % MgCl₂ increases, temperature increases. Therefore, a solution having enough MgCl, concentration to generate enough heat to make the thermoformable body formable must be selected, without providing too much MgCl₂ in order to avoid the production of high levels of heat which may burn a user or damage the thermoformable body. It has been found that generally a range of 5%-20% MgCl₂ by weight in the mixed solution of MgCl₂ and water generates the proper level of heat to make the thermoformable body thermoformable while preventing burns to a user or damage to the thermoformable body.

Although MgCl₂ was been disclosed and given as an example, examples of other salts having a negative enthalpy of solution may be used as well. For example, the following table shows the enthalpy of solution for other salts which may be utilized as the heating material:

| Salt | Enthalpy of Solution (kJ/mol) |
|---|---|
| LiCl | −37 |
| Lil | −63 |
| CuSO₄ | −66 |
| FeCl₂ | −133 |
| MgSO₄ | −91 |
| CaCl₂ | −82 |
| MgCl₂ | −155 |

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

What is Claimed is:

1. A thermoformable article comprising:
a body constructed using material which is rigid at temperatures below a thermoformable temperature and becomes formable when heated to a temperature of above a thermoformable temperature;
a heater material, the heater material being in thermal contact with the body when the heater material is activated, wherein the heat generated by the heater material when activated is provided by an enthalpy of solution of the heater material.

2. The thermoformable article according to claim 1, wherein the body includes at least one of polylactic acid (PLA) polymer, cellulose acetate butyrate, polycaprolactone, ethylene vinyl acetate, poly(caprolactone), poly(hydroxybutyrate), polyethylene, polypropylene, polystyrene.

3. The thermoformable article according to claim 1 further comprising water, the water initially being isolated from the heater material and the heater material having a weight between 5% and 20% of the total combined weight of the heater material, the water and any additional additives, wherein the heater material becomes activated when the water is combined therewith.

4. The thermoformable article according to claim 1, wherein the heater material includes at least one from the group comprising. MgCl₂, KCl, KBr, NaCl, LiCl, LiI, CuSO₄, FeCl₂, MgSO₄, CaCl₂ and CaO.

5. The thermoformable article according to claim 1, wherein the heater material is a salt or mixture of salts having a negative enthalpy of solution, and wherein the salt or mixture of salts is activated through hydration.

6. The thermoformable article according to claim 1, wherein the heater material is physically isolated from the body.

7. The thermoformable article according to claim 6, wherein further comprising a barrier film bag, the barrier film having a first compartment and a second compartment separated by a frangible seal, the heater material being housed within the first compartment and water being housed in the second compartment, wherein the first compartment includes a vent hole and breaking the frangible seal causes the heater material and water to mix, activating the heater material.

8. The thermoformable article according to claim 7 wherein the barrier film bag removably attaches to a first side of the body.

9. The thermoformable article according to claim 8, further comprising a barrier film, wherein the heater material is deposited on a first side of the barrier film and covered with a peelable flap and the second side of the barrier film removably attaches to a surface of the body.

10. The thermoformable article according to claim 1, wherein the body includes at least one cavity formed in a first surface of the body, the at least one cavity having heater material embedded therein.

11. The thermoformable article according to claim 10 further comprising a wicking layer, the wicking layer being removably engaged the first surface of the body to cover the first surface, the at least one cavity and the heater material embedded therein.

12. The thermoformable article according to claim 10 further comprising a barrier film bag having a first compartment and a second compartment separated by a frangible seal, wherein
the first compartment houses water;
the second compartment includes a vent hole and houses the body,
wherein the water mixes with the heater material when the frangible seal is broken, causing the heater material to become activated.

13. The thermoformable article according to claim 10 further comprising a barrier film bag having
a removable portion;
an interior pouch for housing the body; and
a second pouch containing water.

14. The thermoformable article according to claim 13 wherein barrier film bag includes a notch for removing the removable portion.

15. The thermoformable article according to claim 10 further comprising a barrier film bag baying a removable portion and a first compartment and a second compartment separated by a permanent seal, wherein
the first compartment houses a water soaked pad; and
the second compartment houses the body.

16. The thermoformable article according to claim 15 wherein barrier film bag includes a notch for removing the removable portion.

17. The thermoformable article according to claim 1 further comprising a thickening agent, the thickening agent being included in water or the heater material.

18. The thermoformable article according to any of claims 1-17 further comprising wax, the wax being included in water or the heater material.

19. A method of forming a thermoformable article, the method comprising the steps of:
providing a thermoformable body;
placing a heater material in thermal contact with the thermoformable body;
activating the heater material in order to generate heat to form the thermoformable body,
wherein heat is generated by an enthalpy of solution of the heater material.

20. (canceled)

21. (canceled)
